(19) United States
(12) Patent Application Publication
(10) Pub. No.: US 2018/0003822 A1
(43) Pub. Date: Jan. 4, 2018

(54) ENVIRONMENTAL SENSING DEVICE AND INFORMATION ACQUIRING METHOD APPLIED TO ENVIRONMENTAL SENSING DEVICE

(71) Applicant: Baidu Online Network Technology (Beijing) Co., Ltd, Beijing (CN)

(72) Inventors: Bo Li, Beijing (CN); Tianlei Zhang, Beijing (CN); Zongtao Fan, Beijing (CN)

(21) Appl. No.: 15/387,447

(22) Filed: Dec. 21, 2016

(30) Foreign Application Priority Data
Jul. 1, 2016 (CN) 201610512841.X

(51) Int. Cl. G01S 17/08; G01S 17/93; G05D 1/00; G05D 1/02

(52) U.S. Cl. CPC G01S 17/08; G05D 1/0238; G01S 17/936; G05D 1/0088; G05D 2201/0213

(57) ABSTRACT

Disclosed are embodiments of environmental sensing devices and information acquiring methods applied to environmental sensing devices. In some embodiments, an environmental sensing device includes a camera sensor, a laser radar sensor that are integrated, and a control unit. The control unit is connected simultaneously to the camera sensor and the laser radar sensor. The control unit is used for simultaneously entering a trigger signal to the camera sensor and the laser radar sensor. The design of integrating the camera sensor and the laser radar sensor avoids the problems such as poor contact and noise generation that easily occur in a high-vibration and high-interference vehicle environment, and can precisely trigger the camera sensor and the laser radar sensor simultaneously, so as to obtain high-quality fused data, thereby improving the accuracy of environmental sensing. As a result, the camera sensor and the laser radar sensor have a consistent overlapping field of view.

### CROSS-REFERENCE TO RELATED APPLICATION

This application claims priority to Chinese Patent Application No. 201610512841.X, entitled “Environmental Sensing Device And Information Acquiring Method Applied To Environmental Sensing Device” filed on Jul. 1, 2016, which is incorporated herein by reference in its entirety.

### TECHNICAL FIELD

The present disclosure relates to the field of electronic devices, specifically to the field of sensing devices, and more specifically to an environmental sensing device and an information acquiring method applied to an environmental sensing device.

### BACKGROUND

Autonomous driving systems or driver assistance systems generally need to use a camera and a laser radar to collect an image and laser point cloud data so as to obtain fused data, and analyze the fused data to sense the driving environment of the vehicle. Therefore, the use of a camera and a laser radar to collect an image and laser point cloud data so as to obtain fused data is the basis of sensing the driving environment of the vehicle and ensuring safe driving of the vehicle. At present, a commonly used method for obtaining fused data is as follows: a camera and a laser radar are designed as discrete components and are separately mounted on a vehicle, and an additional trigger signal is simultaneously entered into the camera and the laser radar through a connecting line, to trigger the camera and the laser radar to collect an image and laser point cloud data, and to obtain fused data.

However, when the above-mentioned method is used to obtain fused data, on one hand, the discrete design of the camera and the laser radar easily leads to the problems such as poor contact and noise generation in a high-vibration and high-interference vehicular environment. On the other hand, the camera and the laser radar cannot ensure maximum field-of-view overlapping due to their differences in shape and viewing angle, and there will be an offset between their relative positions due to long-term vibration of the vehicle, affecting the precision of the data fusion, making it difficult to obtain high-quality fused data, and reducing the accuracy of environmental sensing.

### SUMMARY

An objective of the present disclosure is to provide an environmental sensing device and an information acquiring method applied to an environmental sensing device, so as to solve the technical problems mentioned in the Background section.

According to a first aspect, the present disclosure provides an environmental sensing device, comprising: a camera sensor and a laser radar sensor that are integrated, and a control unit connected simultaneously to the camera sensor and the laser radar sensor, wherein the control unit is used for simultaneously entering a trigger signal to the camera sensor and the laser radar sensor, so as to simultaneously trigger the camera sensor and the laser radar sensor to collect an image and laser point cloud data.

According to a second aspect, the present disclosure provides an information acquiring method applied to an environmental sensing device, wherein the environmental sensing device comprises a camera sensor and a laser radar sensor that are integrated, the method comprising: receiving a data collection instruction; and simultaneously sending a trigger signal to the camera sensor and the laser radar sensor, so as to simultaneously trigger the camera sensor and the laser radar sensor to collect an image and laser point cloud data.

According to the environmental sensing device and the information acquiring method applied to an environmental sensing device that are provided by the present disclosure, the environmental sensing device comprises a camera sensor and a laser radar sensor that are integrated, and a control unit connected integrated to the camera sensor and the laser radar sensor, wherein the control unit is used for simultaneously inputting a trigger signal to the camera sensor and the laser radar sensor, so as to simultaneously trigger the camera sensor and the laser radar sensor to collect an image and laser point cloud data. On one hand, the design of integrating the camera sensor and the laser radar sensor avoids the problems such as poor contact and noise generation that easily occur in a high-vibration and high-interference vehicle environment, and can precisely trigger the camera sensor and the laser radar sensor simultaneously, so as to obtain high-quality fused data, thereby improving the accuracy of environmental sensing. On the other hand, it can be ensured that the camera sensor and the laser radar sensor have a consistent overlapping field of view.

### BRIEF DESCRIPTION OF THE DRAWINGS

Other features, purposes and advantages of the present disclosure will become more apparent from reading of the detailed description of the non-limiting embodiments, said description being given in relation to the accompanying drawings, among which:

FIG. 1 is a schematic structural diagram of an environmental sensing device according to some embodiments of the present disclosure;

FIG. 2 is a schematic diagram showing the effect that a camera sensor and a laser radar sensor have a consistent overlapping field of view according to some embodiments;

FIG. 3 is a schematic structural diagram of an environmental sensing device according to some embodiments of the present disclosure; and

FIG. 4 is a flow chart of an information acquiring method applied to an environmental sensing device according to some embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

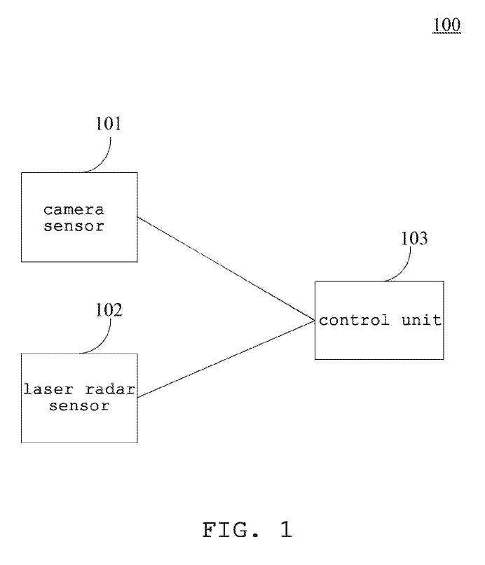

Referring to FIG. 1, FIG. 1 is a schematic structural diagram of an environmental sensing device according to some embodiments of the present disclosure.

As shown in FIG. 1, the environmental sensing device 100 includes: a camera sensor 101 and a laser radar sensor 102 that are integrated, and a control unit 103. The control unit 103 is connected integrated to the camera sensor and the laser radar sensor. The control unit 103 is used for simultaneously entering a trigger signal to the camera sensor 101 and the laser radar sensor 102, so as to simultaneously trigger the camera sensor 101 and the laser radar sensor 102 to collect an image and laser point cloud data.

In this embodiment, the camera sensor 101 and the laser radar sensor 102 may be fixed in a module adjacent to each other. For example, the laser radar sensor 102 may be stacked on the camera sensor 101. The camera sensor 101 and the laser radar sensor 102 may have a consistent overlapping field of view. The control unit 103 may be connected integrated to the camera sensor 101 and the laser radar sensor 102. When the camera sensor 101 and the laser radar sensor 102 need to be controlled to collect an image and laser point cloud data, the control unit 103 may simultaneously send a trigger signal to the camera sensor 101 and the laser radar sensor 102, to simultaneously trigger the camera sensor 101 and the laser radar sensor 102 to collect an image and laser point cloud data, so that the camera sensor and the laser radar sensor synchronously work to simultaneously collect an image and laser point cloud data.

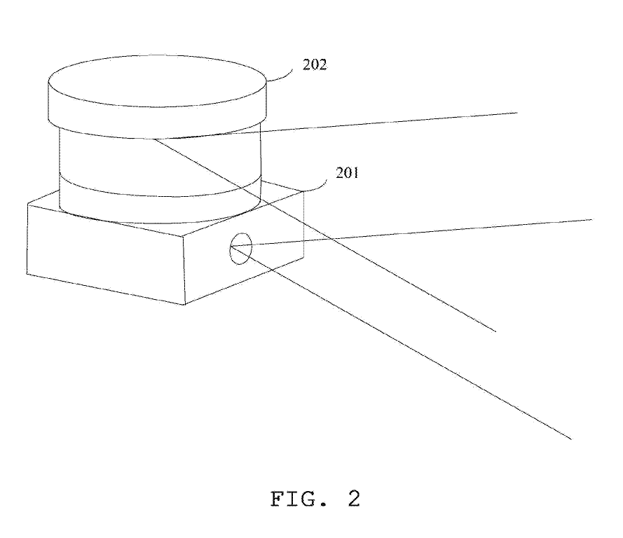

Referring to FIG. 2, FIG. 2 is a schematic diagram showing the effect that a camera sensor and a laser radar sensor have a consistent overlapping field of view.

FIG. 2 shows the camera sensor 201 and the laser radar sensor 202. The laser radar sensor 202 may be stacked on the camera sensor 201, and fixed in a module adjacent to the camera sensor 201. The camera sensor 201 and the laser radar sensor 202 may have a consistent overlapping field of view.

In some optional implementations of this embodiment, the camera sensor and the laser radar sensor are rigidly connected.

In this embodiment, the camera sensor and the laser radar sensor may be rigidly connected, so that the environmental sensing device has good anti-vibration performance. The integral electronic circuit design can ensure the stability of connecting lines and shielding against electromagnetic interference. Whereby, the problems such as poor contact and noise generation that easily occur in a high-vibration and high-interference vehicle environment are avoided, and the camera sensor and the laser radar sensor can be precisely triggered simultaneously.

In some optional implementations of this embodiment, trigger signal input ends of the camera sensor and the laser radar sensor are connected to a same trigger signal input line, so as to receive the trigger signal sent from the control unit through the trigger signal input line.

In this embodiment, the trigger signal input ends of the camera sensor and the laser radar sensor may be connected to a same trigger signal input line, so that the control unit can send the trigger signal to the camera sensor and the laser radar sensor through the trigger signal input line, to trigger the camera sensor and the laser radar sensor to simultaneously enter a working state to simultaneously collect an image and laser point cloud data.

In some optional implementations of this embodiment, the control unit includes: a clock subunit for generating the trigger signal according to a preset frequency; and a clock synchronization subunit for receiving an external clock signal and calibrating and synchronizing the clock subunit by using the external clock signal, the external clock signal including a GPS clock signal or a Network Time Protocol (NTP) signal, that is, a network time signal.

In this embodiment, the clock subunit may be used to generate, according to the preset frequency, the trigger signal for triggering the camera sensor and the laser radar sensor. The clock synchronization subunit may be used to receive the external clock signal and calibrate and synchronize the clock subunit by using the external clock signal.

In some optional implementations of this embodiment, the environmental sensing device further includes: a digital model unit for acquiring a conversion relationship between a coordinate system of the camera sensor and a coordinate system of the laser radar sensor.

In some optional implementations of this embodiment, the environmental sensing device further includes: a preprocessing unit for adding timestamp information to the image and the laser point cloud data; finding, in the image, color information corresponding to each laser point data in the laser point cloud data according to the conversion relationship between the coordinate system of the camera sensor and the coordinate system of the laser radar sensor; and generating laser point cloud data corresponding to the color information.

In this embodiment, the digital model unit may be used to acquire the conversion relationship between the coordinate system of the camera sensor and the coordinate system of the laser radar sensor. After the control unit sends the trigger signal to the camera sensor and the laser radar sensor to trigger the camera sensor and the laser radar sensor to simultaneously collect an image and laser point cloud data, the preprocessing unit may be used to add the timestamp information to the image and the laser point cloud data. The timestamp information may be used for indicating the time at which the image and the laser point cloud data are collected. Then, the color information corresponding to each laser point data in the laser point cloud data may be found in the collected image according to the conversion relationship between the coordinate system of the camera sensor and the coordinate system of the laser radar sensor that is acquired by the digital model unit, and laser point cloud data corresponding to the color information may be generated. Therefore, an external sensing environment can perform further processing on the laser point cloud data corresponding to the color information.

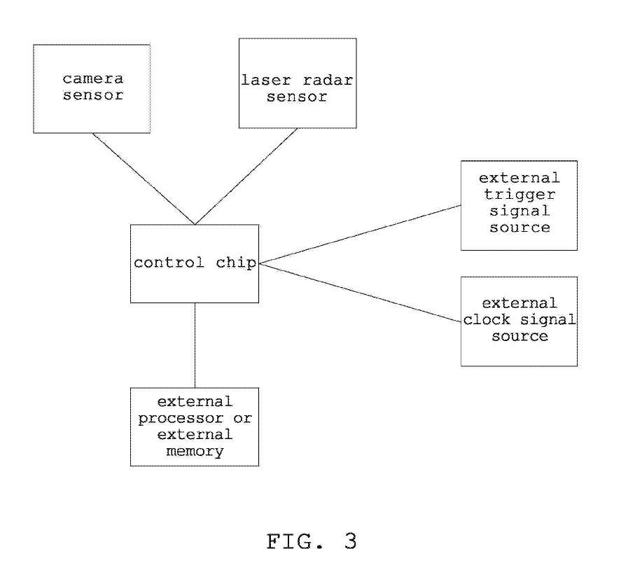

Referring to FIG. 3, FIG. 3 is a schematic structural diagram of an environmental sensing device according to some embodiments of the present disclosure.

The environmental sensing device includes a camera sensor, a laser radar sensor, and a control chip. The camera sensor and the laser radar sensor may be fixed in a module adjacent to each other, and ensure a consistent viewing angle, that is, have a consistent overlapping field of view. The control chip is connected integrated to the camera sensor and the laser radar sensor. The control chip may use a field-programmable gate array. The control chip may simultaneously send a trigger signal to the camera sensor and the laser radar sensor, so as to simultaneously trigger the camera sensor and the laser radar sensor to collect an image and laser point cloud data.

In this embodiment, the control chip may be connected to an external trigger signal source, and may send the trigger signal to the camera sensor and the laser radar sensor by using the external trigger signal source. For example, the trigger signal may be from an external algorithm processor, and trigger the camera sensor and the laser radar sensor to collect an image and laser point cloud data according to algorithm needs.

In this embodiment, the control chip may include a clock. The clock may be used for generating, according to a preset frequency, the trigger signal for triggering the camera sensor and the laser radar sensor. The control chip may be connected to an external clock source, and may calibrate and synchronize the clock of the control chip by using the external clock source. The external clock source may be a GPS clock signal source or a network time signal source.

In this embodiment, the control chip may record a trigger timestamp of the image and the laser point cloud data that are collected after the camera sensor and the laser radar sensor are simultaneously triggered. The trigger timestamp may be used for indicating the time at which the image and the laser point cloud data are collected. The trigger timestamp may be transmitted to an external processor or external memory by using a data transmission interface configured by the control chip. The data transmission interface may include, but not limited to, an Ethernet interface and a USB interface.

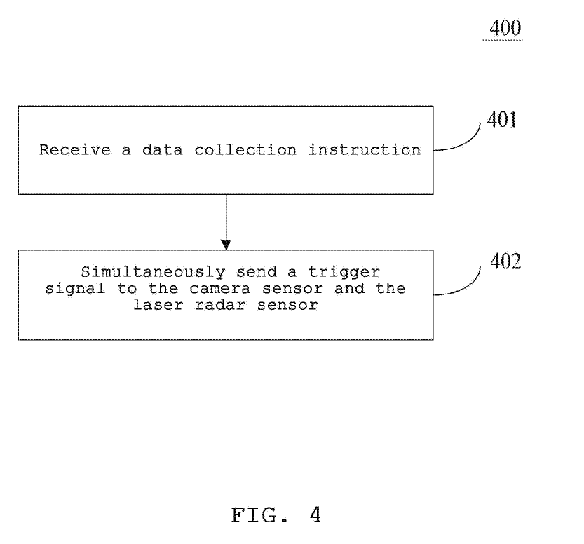

Referring to FIG. 4, FIG. 4 shows a flow 400 of an information acquiring method applied to an environmental sensing device according to some embodiments of the present disclosure. The method includes the following steps:

Step 401. Receive a data collection instruction.

In this embodiment, the environmental sensing device may be mounted on an autonomous driving vehicle. The environmental sensing device includes a camera sensor and a laser radar sensor that are integrated. The camera sensor and the laser radar sensor may be fixed in a module adjacent to each other. For example, the laser radar sensor may be stacked on the camera sensor. The camera sensor and the laser radar sensor may have a consistent overlapping field of view.

In this embodiment, when the camera sensor and the laser radar sensor needs to collect an image and laser point cloud data, for example, when an obstacle recognition process running in a control system of the autonomous driving vehicle needs an image and laser point cloud data, a data collection instruction may be generated.

In this embodiment, a data collection process for controlling the camera sensor and the laser radar sensor to collect an image and laser point cloud data may be created, and the data collection instruction may be received by using the data collection process.

Step 402. Simultaneously send a trigger signal to the camera sensor and the laser radar sensor.

In this embodiment, after the data collection instruction is received in step 401, a trigger signal may be simultaneously sent to the camera sensor and the laser radar sensor, so as to simultaneously trigger the camera sensor and the laser radar sensor to collect an image and laser point cloud data.

In this embodiment, trigger signal input ends of the camera sensor and the laser radar sensor may be connected to a same trigger signal input line, so that the trigger signal can be sent to the camera sensor and the laser radar sensor through the trigger signal input line, to trigger the camera sensor and the laser radar sensor to simultaneously enter a working state to simultaneously collect an image and laser point cloud data.

In some optional implementations of this embodiment, the method further includes: receiving an external clock signal; and calibrating and synchronizing a preset clock by using the external clock signal, the external clock signal including a GPS clock signal and a network time signal, and the preset clock being used for generating the trigger signal according to a preset frequency.

In this embodiment, the trigger signal for triggering the camera sensor and the laser radar sensor may be generated by the preset clock. The preset clock may be used for generating, according to the preset frequency, the trigger signal for triggering the camera sensor and the laser radar sensor.

In this embodiment, the external clock signal may be received, and the preset clock may be calibrated and synchronized by using the external clock signal.

In some optional implementations of this embodiment, the method further includes: acquiring a conversion relationship between a coordinate system of the camera sensor and a coordinate system of the laser radar sensor.

In some optional implementations of this embodiment, the method further includes: adding timestamp information to the image and the laser point cloud data; finding, in the image, color information corresponding to each laser point data in the laser point cloud data according to the conversion relationship between the coordinate system of the camera sensor and the coordinate system of the laser radar sensor; and generating laser point cloud data corresponding to the color information.

In this embodiment, after the camera sensor and the laser radar sensor are simultaneously triggered to simultaneously collect an image and laser point cloud data, timestamp information may be added to the image and the laser point cloud data. The timestamp information may be used for indicating the time at which the image and the laser point cloud data are collected. Then, the color information corresponding to each laser point data in the laser point cloud data may be found in the collected image according to the acquired conversion relationship between the coordinate system of the camera sensor and the coordinate system of the laser radar sensor, and laser point cloud data corresponding to the color information may be generated. Therefore, an external sensing environment can perform further processing on the laser point cloud data corresponding to the color information.

The foregoing is only a description of embodiments of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the disclosure, such as, technical solutions formed by replacing the features as disclosed in the present disclosure with (but not limited to), technical features with similar functions.

Various components illustrated in the figures may be implemented as hardware and/or software and/or firmware on a processor, ASIC/FPGA, dedicated hardware, and/or logic circuitry. Also, the features and attributes of the specific embodiments disclosed above may be combined in different ways to form additional embodiments, all of which fall within the scope of the present disclosure. Although the present disclosure provides certain embodiments and disclosures, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. An environmental sensing device, comprising:
an integrated camera sensor;
a laser radar sensor; and
a control unit connected simultaneously to the camera sensor and the laser radar sensor,
wherein the control unit is configured to simultaneously enter a trigger signal to the camera sensor and the laser radar sensor so as to simultaneously trigger the camera sensor and the laser radar sensor to collect an image and laser point cloud data.

2. The environmental sensing device according to claim 1, wherein the camera sensor and the laser radar sensor are rigidly connected.

3. The environmental sensing device according to claim 2, wherein trigger signal input terminals of the camera sensor and the laser radar sensor are connected to a single trigger signal input line so as to receive the trigger signal sent from the control unit through the trigger signal input line.

4. The environmental sensing device according to claim 3, wherein the control unit comprises:
a clock subunit for generating the trigger signal according to a preset frequency; and
a clock synchronization subunit for receiving an external clock signal and calibrating and synchronizing the clock subunit by using the external clock signal, the external clock signal comprising a GPS clock signal or a network time signal.

5. The environmental sensing device according to claim 4, wherein the environmental sensing device further comprises:
a digital model unit for acquiring a conversion relationship between a coordinate system of the camera sensor and a coordinate system of the laser radar sensor.

6. The environmental sensing device according to claim 5, wherein the environmental sensing device further comprises:
a preprocessing unit for adding timestamp information to the image and the laser point cloud data; finding, in the image, color information corresponding to each laser point data in the laser point cloud data according to the conversion relationship between the coordinate system of the camera sensor and the coordinate system of the laser radar sensor; and generating laser point cloud data corresponding to the color information.

7. An information acquiring method applied to an environmental sensing device, wherein the environmental sensing device comprises a camera sensor and a laser radar sensor that are integrated, the method comprising:
receiving a data collection instruction; and
simultaneously sending a trigger signal to the camera sensor and the laser radar sensor so as to simultaneously trigger the camera sensor and the laser radar sensor to collect an image and laser point cloud data.

8. The method according to claim 7, wherein the method further comprises:
receiving an external clock signal; and
calibrating and synchronizing a preset clock by using the external clock signal, the external clock signal comprising a GPS clock signal or a network time signal, and the preset clock being used for generating the trigger signal according to a preset frequency.

9. The method according to claim 8, wherein the method further comprises:
acquiring a conversion relationship between a coordinate system of the camera sensor and a coordinate system of the laser radar sensor.

10. The method according to claim 9, wherein the method further comprises:
adding timestamp information to the image and the laser point cloud data; finding, in the image, color information corresponding to each laser point data in the laser point cloud data according to the conversion relationship between the coordinate system of the camera sensor and the coordinate system of the laser radar sensor; and generating laser point cloud data corresponding to the color information.

11. A non-transitory computer storage medium storing a computer program, which when executed by one or more processors in an environmental sensing device comprising a camera sensor and a laser radar sensor that are integrated, cause the one or more processors to perform operations comprising:
receiving a data collection instruction; and
simultaneously sending a trigger signal to the camera sensor and the laser radar sensor, so as to simultaneously trigger the camera sensor and the laser radar sensor to collect an image and laser point cloud data.

12. The non-transitory computer storage medium according to claim 11, wherein the operations further comprise:
receiving an external clock signal; and
calibrating and synchronizing a preset clock by using the external clock signal, the external clock signal comprising a GPS clock signal or a network time signal, and the preset clock being used for generating the trigger signal according to a preset frequency.

13. The non-transitory computer storage medium according to claim 11, wherein the operations further comprise:
acquiring a conversion relationship between a coordinate system of the camera sensor and a coordinate system of the laser radar sensor.

14. The non-transitory computer storage medium according to claim 11, wherein the operations further comprise:
adding timestamp information to the image and the laser point cloud data; finding, in the image, color information corresponding to each laser point data in the laser point cloud data according to the conversion relationship between the coordinate system of the camera sensor and the coordinate system of the laser radar sensor; and
generating laser point cloud data corresponding to the color information.
